(19) United States
(12) Patent Application Publication
(10) Pub. No.: US 2013/0047506 A1
(43) Pub. Date: Feb. 28, 2013

(54) HANGING PLANTER ASSEMBLY

(71) Applicants: Daniel E. Sheaffer, Findlay, OH (US); Daniel McNinch, Fostoria, OH (US); Terry M. Birchler, New Albany, OH (US); Shawn M. Whetstone, New Albany, OH (US)

(72) Inventors: Daniel E. Sheaffer, Findlay, OH (US); Daniel McNinch, Fostoria, OH (US); Terry M. Birchler, New Albany, OH (US); Shawn M. Whetstone, New Albany, OH (US)

(73) Assignee: Garden-Aire, LLC, Findlay, OH (US)

(21) Appl. No.: 13/400,040

(22) Filed: Feb. 18, 2012

Related U.S. Application Data
(63) Continuation of application No. PCT/US10/45703, filed on Aug. 17, 2010.
(60) Provisional application No. 61/234,801, filed on Aug. 18, 2009.

(51) Int. Cl. A01G 9/02

(52) U.S. Cl. 47/67

(57) ABSTRACT

A hanging planter assembly includes a support strap adapted to be secured to a vertically extending member and a container supported on the support strap.

### CROSS-REFERENCE TO RELATED APPLICATIONS

This application is a continuation of International Application No. PCT/US 10/45703, filed Aug. 17, 2010, which claims priority from U.S. Provisional Application No. 61/234,801, filed Aug. 18, 2009. The disclosures of both applications are incorporated herein by reference.

### BACKGROUND OF THE INVENTION

Planter assemblies are often supported for elevated use on trees and other vertically extending members, such as poles, columns, and posts. Such planter assemblies are easy to use, portable, and durable. They often have built-in drainage and are suitable for outdoor, indoor, residential, municipal, and commercial applications. They can be used individually or in combination to provide different aesthetically-pleasing configurations. Certain planter assemblies can provide a high class quality and appearance for a low investment.

### BRIEF DESCRIPTION OF THE DRAWINGS

FIG. 1 is a perspective view of a first embodiment of a hanging planter assembly in accordance with this invention.

FIG. 2 is a perspective view from the top of a portion of the first embodiment of the hanging planter assembly illustrated in FIG. 1.

FIG. 3 is a perspective view from the bottom of the portion of the first embodiment of the hanging planter assembly illustrated in FIG. 2.

FIG. 4 is a perspective view of a second embodiment of a hanging planter assembly in accordance with this invention, shown installed on a tree trunk.

FIG. 5 is an enlarged perspective view of a portion of the second embodiment of the hanging planter assembly illustrated in FIG. 4.

FIG. 6 is a further enlarged perspective view of a portion of the second embodiment of the hanging planter assembly illustrated in FIG. 5.

FIG. 7 is a perspective view of the second embodiment of a hanging planter assembly illustrated in FIGS. 4, 5, and 6 with an interchangeable outer skin supported thereon.

FIG. 8 is a perspective view of a third embodiment of a hanging planter assembly in accordance with this invention shown installed on a vertically extending member.

FIG. 9 is a further perspective view of the third embodiment of the hanging planter assembly illustrated in FIG. 8.

### DETAILED DESCRIPTION OF THE PREFERRED EMBODIMENTS

Although specific terms are used in the following description for the sake of clarity, these terms are intended to refer only to the particular structure of the invention selected for illustration in the drawings and are not intended to define or limit the scope of the invention.

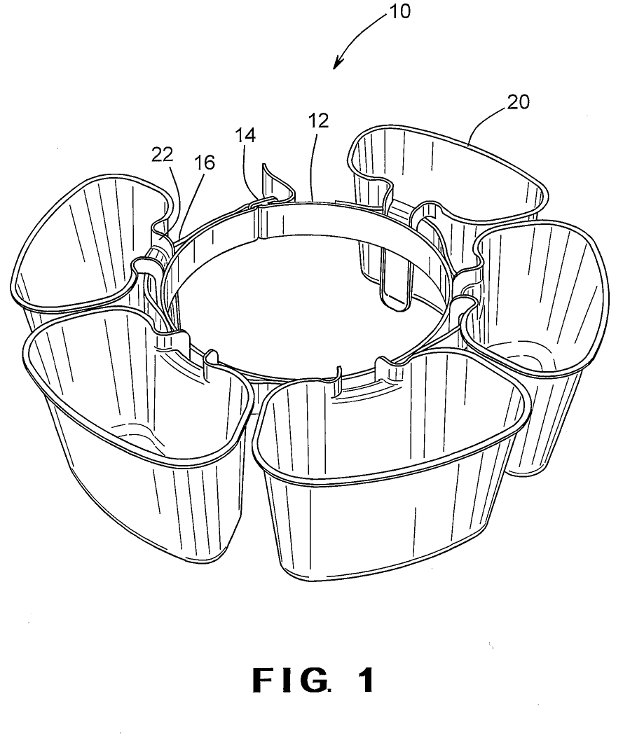

Referring now to the drawings, there is illustrated in FIG. 1 a hanging planter assembly, indicated generally at 10, for supporting potted plants on the outer surface of a vertically extending member, such as a tree, post, or the like. The hanging planter assembly 10 generally includes at least one container 20. The container 20 may be any structure suitable for growing plants or flowers and may be generally arcuate in shape, although any suitable shape is permitted without departing from the scope of the invention.

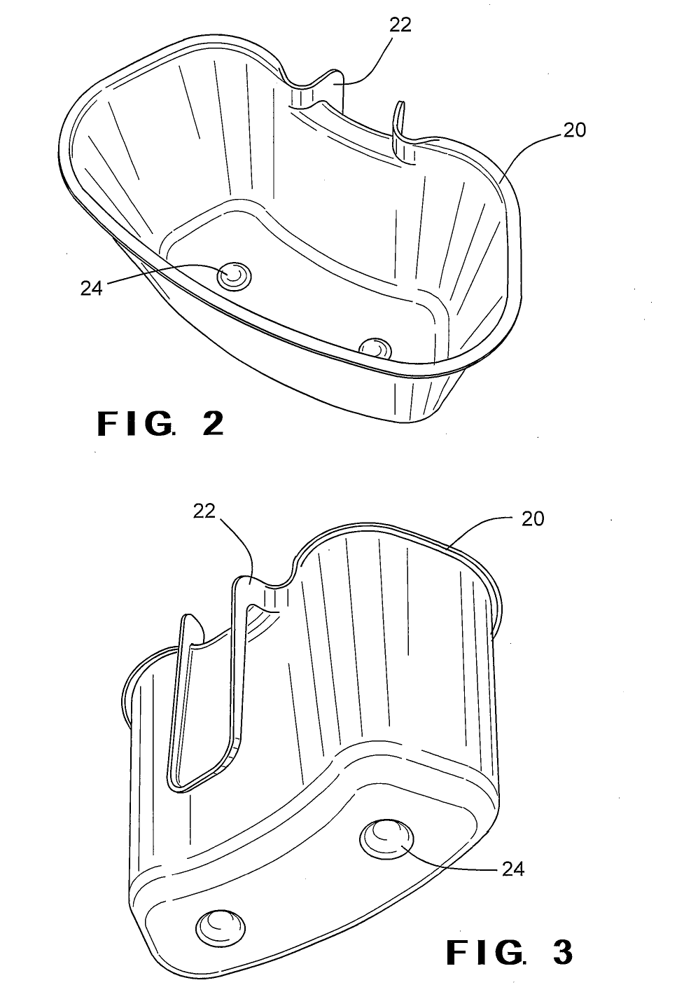

As shown in FIGS. 2 and 3, the container 20 may include at least one aperture 24. The aperture 24 can be configured to allow drainage of water or other fluids from the container 20, although such is not necessary.

As best shown in FIG. 5, the container 20 may include at least one punch hole 26. The punch hole 26 may be located such that a portion of the growing plant or flower (not shown) may protrude or extend therethrough.

As best shown in FIG. 7, the container 20 may include a skin 28 adhered to or otherwise applied to an external surface of the container 20. The skin 28 may be intended for aesthetic purposes, or for any other suitable purpose.

Referring again to FIG. 1, the container 20 may be attached to a support strap 12. The support strap 12 may be any device configured to extend circumferentially about and securely engage with a vertically extending member. The support strap 12 may include a fastener 14 for securely coupling opposing ends of the support strap 12. The fastener 14 may be any suitable mechanism for allowing the support strap 12 to accommodate vertical members of varying cross-sectional areas or shapes. The fastener 14 may also be configured to allow for the simple release or removal of the support strap 12 from the vertically extending member, although such is not necessary. It should be understood that the fastener 14 may be any device configured to securely fasten the support strap circumferentially about a vertically extending member.

Referring now to FIGS. 1-3, there is illustrated a first embodiment of this invention. As illustrated in the first embodiment, the container 20 may include a handle 22. The handle 22 may be radially spaced from the container 20 and extend along an axial length toward a bottom portion of the container 20, although such is not required. The handle 22 can be integrally formed with the container 20. However, it should be appreciated that the handle 22 may also be a separate component fixed to the container 20.

The support strap 12 may include at least one loop 16 configured to attach the container 20 thereto. The loop 16 may be formed in any suitable fashion, such as for example by an overlapping portion of the support strap 14. The handle 22 of the container 20 is adapted to be inserted into the loop 16 of the support strap 12 for vertically supporting the container 20. As shown, a plurality of loops 16 may be circumferentially spaced around the support strap 14 for receiving and supporting a plurality of containers 20.

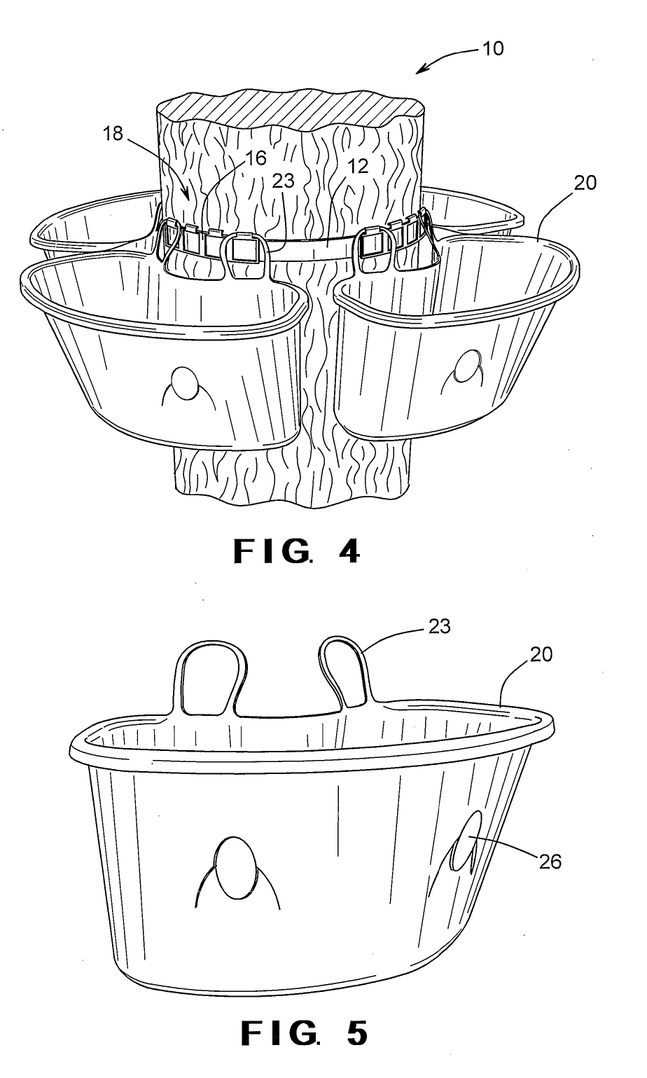

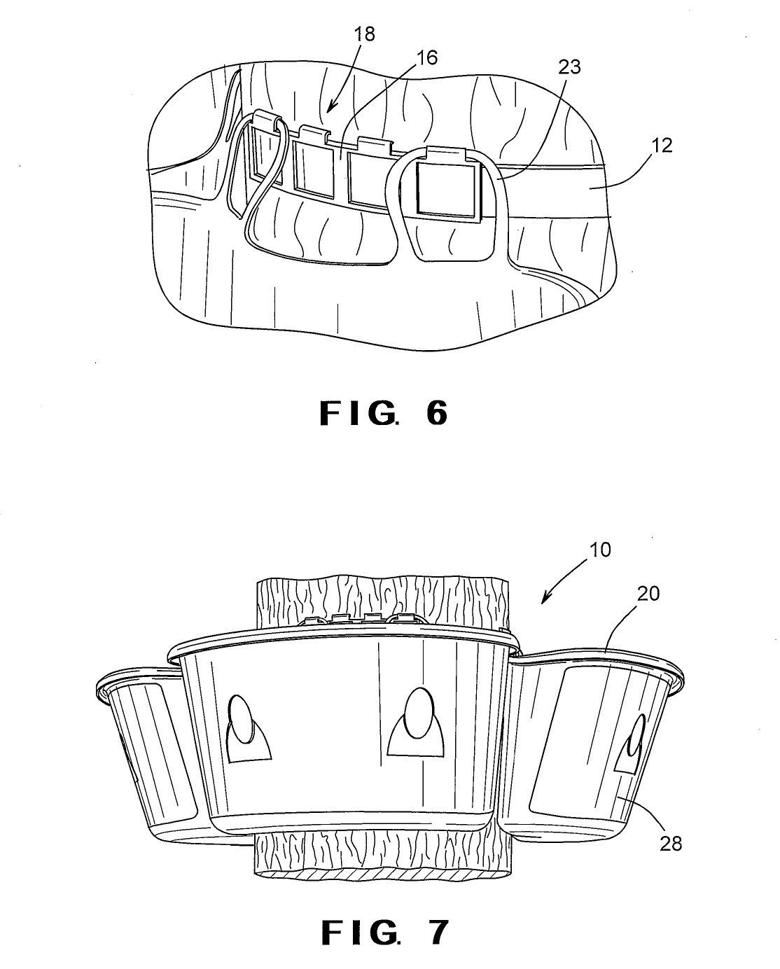

Referring now to FIGS. 4-7, there is illustrated a second embodiment of the present invention. As illustrated in the second embodiment, the container 20 may include at least one support eyelet 23. The support eyelet 23 may have opposing ends attached to the container 20 and extending from a top portion of the container 20 thereby forming an eyelet opening. It should be appreciated that the support eyelet 23 may extend from any portion of the container 20. The support eyelet 23 may be an integral part of the container 20. However, it should be appreciated that the support eyelet 23 may also be a separate component fixed to the container 20 in any suitable manner.

The support strap 12 may include a support clip 16. The support clip 16 is configured to be slidably attached to the support strap 12. The support clip 16 has at least one tab 18 extending from a portion thereof. The support eyelet 23 of the container 20 is configured to engage the tab 18 of the support clip 16, thereby removably fixing the container 20 to the support strap 12.

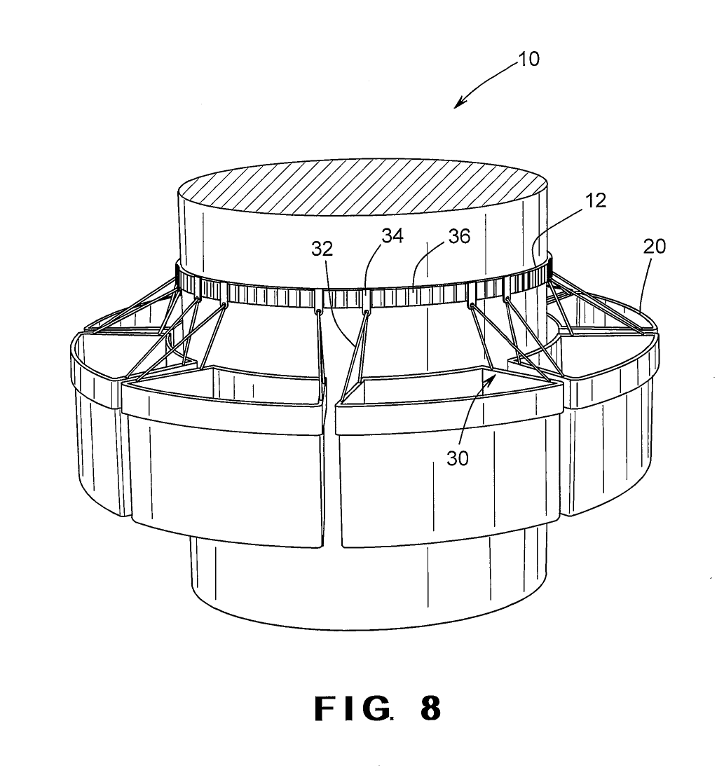

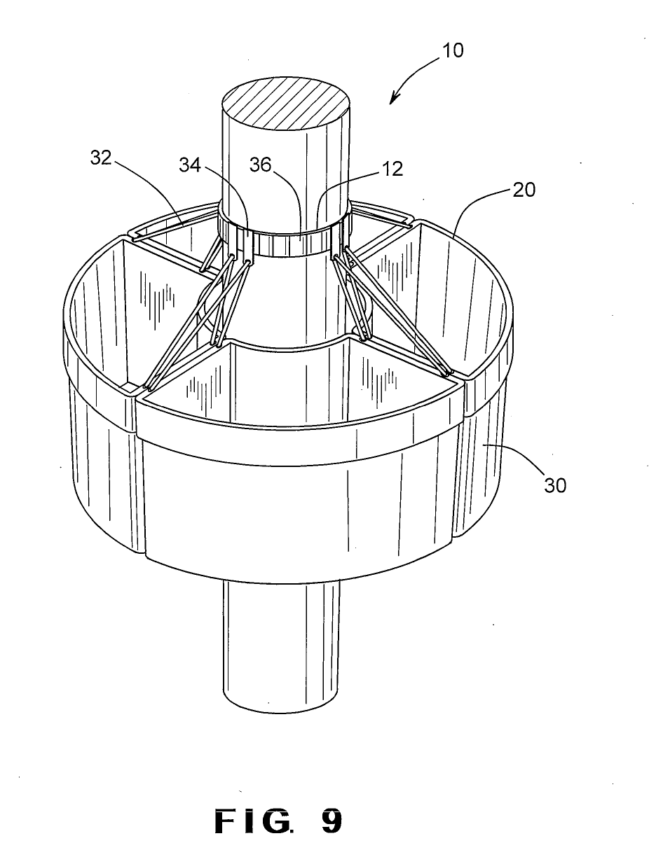

Referring now to FIGS. 8-9, there is illustrated a third embodiment of the present invention. As illustrated in the third embodiment, the container 20 may include at least one passageway, indicated generally by 30, located along an upper edge of the container 20. However, it should be appreciated that the passageway 30 may be located along any external surface of the container 20. A portion of a support cable 32 forming an endless loop is disposed within the passageway 30 such that the support cable 32 is configured to support the container in a suspended fashion. Attached to the support cable 32 for movement along the cable 32 is a hook 34, the purpose of which will be described below.

The support strap 12 may include a plurality of slots 36 circumferentially spaced about the support strap 12 and extending in a vertical direction, although such a direction is not required. The slots 36 may be configured to receive the hook 34, such as for supporting the container 20 by the support cable 32.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A hanging planter assembly comprising:
a support strap adapted to be secured to a vertically extending member; and
a plurality of containers supported on the support strap.

2. The hanging planter defined in claim 1 wherein each of the plurality of containers includes an aperture that is configured to allow drainage of water or other fluids therefrom.

3. The hanging planter defined in claim 1 wherein each of the plurality of containers includes a punch hole that is located such that a portion of a growing plant or flower may protrude or extend therethrough.

4. The hanging planter defined in claim 1 wherein the support strap includes a plurality of loops, and wherein each of the plurality of containers includes a handle that is received in an associated one of the plurality of loops.

5. The hanging planter defined in claim 1 wherein the support strap includes a plurality of support clips, and wherein each of the plurality of containers includes a support eyelet that is received in an associated one of the plurality of support clips.

6. The hanging planter defined in claim 1 wherein each of the plurality of containers includes a support cable that forms an endless loop and that is supported on the support strap.

7. The hanging planter defined in claim 1 wherein each of the plurality of containers includes a support cable that forms an endless loop and that is supported on a hook supported on the support strap.

8. The hanging planter defined in claim 1 wherein each of the plurality of containers includes first and second support cables that form respective endless loops that are supported on the support strap.

9. The hanging planter defined in claim 1 wherein each of the plurality of containers includes first and second support cables that form respective endless loops that are supported on respective hooks supported on the support strap.
